(19) United States
(12) Patent Application Publication
(10) Pub. No.: US 2025/0261117 A1
(43) Pub. Date: Aug. 14, 2025

(54) Upper Layer Aspects of UL Wakeup Signal (WUS) for gNB Paging Power Saving in IDLE/INACTIVE State

(71) Applicant: Apple Inc., Cupertino, CA (US)

(72) Inventors: Peng CHENG, Beijing (CN); Fangli XU, Beijing (CN); Haijing HU, Los Gatos, CA (US)

(21) Appl. No.: 19/116,472

(22) PCT Filed: Sep. 29, 2022
(86) PCT No.: PCT/CN2022/122854

§ 371 Date: Mar. 28, 2025

(51) Int. Cl. H04W 52/02; H04W 68/02; H04W 74/0833; H04W 76/28

(52) U.S. Cl. CPC H04W 52/0235; H04W 68/02; H04W 74/0833; H04W 76/28

(57) ABSTRACT

A user equipment (UE) configured to receive a configuration from a network cell for an uplink (UL) wakeup signal (WUS) resource, determining to transmit a UL WUS when a condition is triggered, the condition comprising the UE being present in an upcoming paging occasion (PO) or beam or the UE intending to receive a paging early indication (PEI), select a sequence for transmitting the UL WUS, the sequence comprising a physical RACH (PRACH) preamble reserved for UL WUS or a sequence introduced for UL WUS and transmit the UL WUS.

### TECHNICAL FIELD

The present disclosure generally relates to wireless communication, and in particular, to upper layer aspects of UL wakeup signal (WUS) for gNB paging power saving in idle/inactive state.

### BACKGROUND INFORMATION

A user equipment (UE) may establish a connection to at least one of a plurality of different networks or types of networks. For some types of network communications, the UE may be configured with a discontinuous reception (DRX) cycle or a discontinuous transmission (DTX) cycle to conserve power, wherein the UE utilizes an active mode (ON duration) of data exchange processing and a sleep mode (OFF duration) of inactivity. In 5G New Radio (NR), techniques can be implemented at the network cell (e.g., base station or gNB) to conserve power, including a cell DRX/DTX cycle where the gNB is configured with an active mode (ON duration) and a sleep mode (OFF duration). A UL wakeup signal (WUS) refers to a layer 1 (L1) signaling transmitted by the UE to notify/request the gNB to wake up from a sleep mode or state. However, the radio resource control (RRC) signaling/configuration and medium access control (MAC) behavior for the UL WUS is not well defined.

### SUMMARY

Some exemplary embodiments are related to a method performed by a user equipment (UE). The method includes receiving a configuration from a network cell for an uplink (UL) wakeup signal (WUS) resource, determining to transmit a UL WUS when a condition is triggered, the condition comprising the UE being present in an upcoming paging occasion (PO) or beam or the UE intending to receive a paging early indication (PEI), selecting a sequence for transmitting the UL WUS, the sequence comprising a physical RACH (PRACH) preamble reserved for UL WUS or a sequence introduced for UL WUS and transmitting the UL WUS.

Other exemplary embodiments are related to a method performed by a base station. The method includes transmitting a configuration to a user equipment (UE) for an uplink (UL) wakeup signal (WUS) resource, receiving the UL WUS when a condition is triggered at the UE, the condition comprising the UE being present in an upcoming paging occasion (PO) or beam or the UE intending to receive a paging early indication (PEI) and determining whether to transmit paging in the upcoming PO or beam.

### BRIEF DESCRIPTION OF THE DRAWINGS

FIG. 1 shows a timing diagram for a DTX/DRX cycle for a cell according to one example.

FIG. 2a shows a diagram for a periodic UL WUS resource configured in association with a paging occasion according to various exemplary embodiments.

FIG. 2b shows a diagram for an aperiodic UL WUS resource configured in association with a paging occasion according to various exemplary embodiments.

FIG. 3 shows an exemplary method for configuring a UL wakeup signal (WUS) resource and transmitting a UL WUS according to various exemplary embodiments.

FIG. 4 shows an exemplary network arrangement according to various exemplary embodiments.

FIG. 5 shows an exemplary base station according to various exemplary embodiments.

FIG. 6 shows an exemplary UE according to various exemplary embodiments.

### DETAILED DESCRIPTION

The exemplary embodiments may be further understood with reference to the following description and the related appended drawings, wherein like elements are provided with the same reference numerals. The exemplary embodiments relate to operations for configuring, triggering and transmitting the UL wakeup signal (WUS) for a UE in the RRC IDLE or INACTIVE state. In particular, medium access layer (MAC) operations are described for the IDLE/INACTIVE UE. In one aspect, UE and network/gNB operations are described for using a system information block (SIB) to configure the resource for the UE to transmit the UL WUS. In another aspect, UE operations are described for triggering the transmission of the UL WUS at the UE. In still another aspect, medium access control (MAC) operations are described for an idle/inactive UE to send the UL WUS. In still another aspect, gNB operations are described upon reception of the UL WUS.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a 5G New Radio (NR) radio access network (RAN). However, reference to a 5G NR RAN is merely provided for illustrative purposes. The exemplary embodiments may be utilized with any network implementing DRX/DTX cycles similar to those described herein. Therefore, the 5G NR network as described herein may represent any type of network implementing similar DRX/DTX functionalities as the 5G NR network.

A DRX cycle can be configured for a UE according to existing methodologies to conserve UE power. The DRX cycle utilizes an active mode of data exchange processing and a sleep mode of inactivity. The UE may use the active mode of processing at defined intervals to perform scheduled operations such as performing measurements related to the network conditions, transmitting (e.g., requests, measurement reports, uplink data etc.), and receiving (e.g., control channel information, reference signals, synchronization signals, downlink data, etc.). The time period that the UE may be scheduled to receive may be referred to as the ON duration for the DRX cycle, or a DRX active time. The ON duration for a DRX cycle relates to a duration during which the UE may perform operations that enable the UE to receive data that may be transmitted to the UE such as but not limited to, control channel information, an uplink grant, a downlink grant, reference signals, synchronization signals, payload data etc.

During the DRX cycle, when an ON duration is not scheduled, the UE may have an opportunity to utilize the sleep mode of inactivity and conserve power. This period may be referred to as the OFF duration for the DRX cycle, or a DRX inactive time. However, reference to a DRX cycle is for illustrative purposes, and different networks may refer to similar concepts by a different name. The DRX cycle may have a predetermined duration N such as 100 milliseconds (ms), 50 ms, 40 ms, 20 ms, etc. For example, at a time 0, there may be a ON duration during which the active mode of processing is used. Subsequently, upon the conclusion of the ON duration, the UE has an opportunity to utilize the sleep mode of inactivity. Then at a time N, there may be another ON duration. Subsequently, the sleep mode is used until a time 2N. This process continues for the duration of the DRX cycle. Reference to the sleep mode of inactivity does not necessarily mean putting the processor, the transmitter, and the receiver of the UE to sleep, in hibernation, or in deactivation. For example, the processor (e.g., baseband and/or application) may continue to execute other applications or processes. The sleep mode relates to conserving power by discontinuing a continuous processing functionality relating to operations that enable the UE to receive data that may be transmitted to the UE and transmit data to the network. Further, reference to the DRX cycle being configured in ms units is merely for illustrative purposes, the exemplary aspects may utilize a DRX cycle that is based on subframes or any other suitable unit of time.

In Rel-18, techniques can be implemented on both the gNB and user equipment (UE) side to improve network energy consumption, e.g., base station transmission and reception power. These techniques may include more efficient dynamic and/or semi-static operations and finer granularity adaptation of transmissions and/or receptions and relate to the time, frequency, spatial, and/or power domains, with potential support/feedback from the UE, and potential UE assistance information. The techniques may further include information exchange/coordination over network interfaces. Additional/other techniques are not precluded. Idle/empty and low/medium load scenarios can be considered (the exact definition of such loads has not yet been defined), and different loads among carriers and neighbor cells are allowed.

In some examples, the power saving techniques can include gNB (cell) discontinuous transmission (DTX) and/or discontinuous reception (DRX) (or ON-OFF pattern) and uplink (UL) wakeup signal (WUS). Similar to the UE DRX cycle described above, a cell DTX/DRX can utilize an ON duration wherein the gNB can transmit/receive signals/channels and an OFF duration wherein the gNB can disable some types of signal Rx/Tx processing and conserve power. Cell DTX/DRX can be applied to the UE in all RRC states (IDLE, INACTIVE, or CONNECTED) and covers both transmit (Tx) and receive (Rx) of the gNB. The signaling design for implementing cell DTX/DRX and UL WUS should consider the RRC state of the UE.

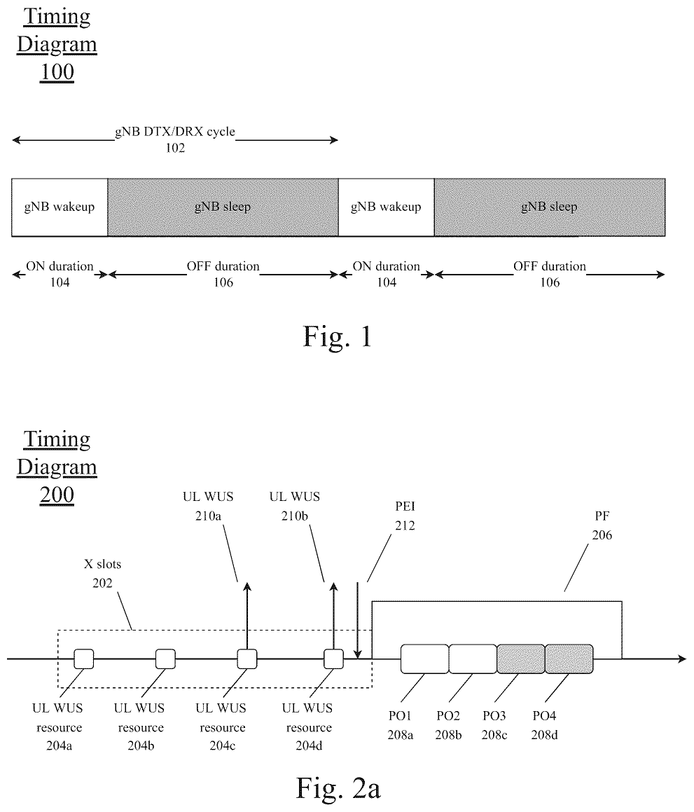

FIG. 1 shows a timing diagram 100 for a DTX/DRX cycle 102 for a cell, e.g., a gNB, according to one example. Each cell DTX/DRX cycle 102 comprises an ON duration 104, during which the power amplifier (PA) and radiofrequency (RF) front end of the gNB are powered on, and an OFF duration 106 when the PA and RF are turned off and the gNB can conserve power. The duration of the cell DTX/DRX cycle 102, and the length of the ON duration 104 relative to the OFF duration 106, can vary.

During the DRX/DTX OFF duration, different gNB sleep modes can be configured for the UE depending on, for example, the power consumption requirements and/or capabilities of different gNBs (e.g., the serving gNB and potentially neighboring gNBs). The sleep modes can correspond to varying levels of power consumption imposed by the Tx/Rx of various types of signals/channels. It is noted that the gNB can configure different sleep modes for different groups of UEs based on various considerations including, e.g., the number of UEs in the cell and the requirements of the various UEs.

The Paging Early Indication (PEI) or Paging Wake Up Signal (WUS) was introduced in Rel-17. The PEI allows the IDLE/INACTIVE UE to know in advance whether the UE has to monitor its paging occasion (PO). This feature allows the UE to go for extended/deep sleep in each PO if there is no paging destined for that UE. The PEI can be configured in system information block (SIB) 1 and triggered via downlink control information (DCI) or reference signal (RS). The UE monitors the search space of the PEI and, upon detection of the PEI, monitors the next PO for, e.g., paging PDCCH. Otherwise, the UE skips detecting the PO. The search space for the PEI is smaller than that of the PDCCH, leading to power savings when the UE can skip monitoring the PO. The PEI absolves the need to perform continuous PO and SSB monitoring and is particularly useful in cases of poor or marginal RF conditions.

To reduce false paging alarms (and further reduce UE power consumption) the group of UEs monitoring the same PO can be divided into subgroups. The PEI can carry a subgroup ID indication and, if the UE detects a PEI with its subgroup ID, the UE monitors the next PO.

An idle/inactive UE can notify/request a gNB to wake up in some upcoming duration via a UL WUS. The UE can notify the gNB of its presence in an upcoming one paging occasion (PO); notify the gNB of its reception of PEI; or notify the gNB of its presence in which beam(s) for paging and PEI reception. The gNB receiving this information can mute PO(s) and/or beams for paging transmission other than those indicated to be used by the UE.

According to various exemplary embodiments described herein, operations are described for configuring, triggering and transmitting the UL wakeup signal (WUS) for a UE in the RRC IDLE or INACTIVE state. In particular, medium access layer (MAC) operations are described for the IDLE/INACTIVE UE. In one aspect, UE and network/gNB operations are described for using a system information block (SIB) to configure the resource for the UE to transmit the UL WUS. In another aspect, UE operations are described for triggering the transmission of the UL WUS at the UE. In still another aspect, medium access control (MAC) operations are described for an idle/inactive UE to send the UL WUS. In still another aspect, gNB operations are described upon reception of the UL WUS.

According to one aspect of these exemplary embodiments, the cell-specific UL WUS resource(s) can be configured in SIB. The SIB can configure a starting slot for the UL WUS resource (e.g., a slot offset) defined relative to an upcoming paging frame (PF). In some embodiments, the WUS resource can be periodic and the SIB configuration can include a periodicity and the starting slot (slot offset). In another embodiment, the WUS resource can be aperiodic and can be triggered by the gNB. In some embodiments, the UL WUS can be sent only when the gNB is in a wake up state, e.g., in the ON duration of a cell DRX/DTX cycle.

The periodic UL WUS resource can be configured ‘x’ slots before the start of every ‘y’ paging frame(s) (PF). The UL WUS resource can be configured in SIB. The SIB can carry a parameter indicating a value ‘x’ for the slot offset relative to a starting time of the ‘y’ PF(s), where ‘y’ is also configurable in SIB. Each UL WUS resource can be configured in association with one PO or one beam.

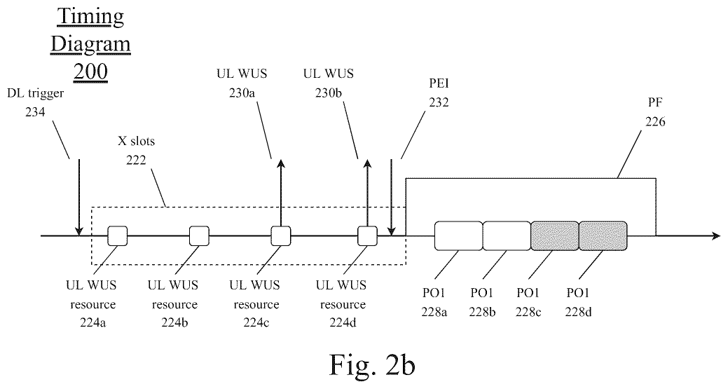

FIG. 2a shows a diagram 200 for a periodic UL WUS resource 204 configured in association with a paging occasion 208 according to various exemplary embodiments. The diagram 200 includes four UL WUS resources 204, e.g., UL WUS resource 204a, UL WUS resource 204b, UL WUS resource 204c, and UL WUS resource 204d, beginning ‘x’ slots before paging frame 206. The paging frame 206 includes four paging occasions (PO) 208, e.g., PO1 208a, PO2 208b, PO3 208c, and PO4 208d. Each UL WUS resource 204 is associated with a respective PO 208, e.g., UL WUS resource 204a is associated with PO1 208a, UL WUS resource 204b is associated with PO2 208b, UL WUS resource 204c is associated with PO3 208c, and UL WUS resource 204d is associated with PO4 208d.

In this example, the UL WUS is not transmitted in the first UL WUS resource 204a or the second UL WUS resource 204b. Thus, the POs 208 associated with these UL WUS resources 204, e.g., PO1 208a and PO2 208b, are muted.

The UE transmits a UL WUS 210 during the third UL WUS resource 204c (e.g., UL WUS 210a) and during the fourth UL WUS resource 204d (e.g., UL WUS 210b). The gNB receiving the UL WUS 210 can determine to send pages during the POs 208 associated with these UL WUS resources 204, e.g., in PO3 208c and PO4 208d. If the gNB decides to respond to the UE, the UE can receive a paging early indication (PEI) 212 prior to the PF 206.

In another exemplary embodiment, the UL WUS resource can be aperiodic. The gNB can configure the UE with the aperiodic UL WUS resource in a similar manner to the periodic UL WUS resource. The aperiodic UL WUS resource can be triggered via group common (GC) signaling.

The starting slot for the aperiodic UL WUS resource can be defined relative to the start of the upcoming PF, similar to above. The aperiodic UL WUS resource is not used/available until it is triggered by the gNB. The trigger can comprise a group common DCI (GC-DCI), e.g., a paging short message or a paging early indication (PEI) DCI 2_7. If cell DRX/DTX is configured, the aperiodic UL WUS resource may be configured only for the ON duration of the cell DRX/DTX cycle, e.g., when the UE is monitoring for paging messages and/or PEI. When the aperiodic UL WUS resource is triggered, the UE can use it to send the UL WUS, if desired, or skip the opportunity to transmit the UL WUS.

FIG. 2b shows a diagram 220 for an aperiodic UL WUS resource 224 configured in association with a paging occasion 228 according to various exemplary embodiments. The diagram 220 includes four UL WUS resources 224, e.g., UL WUS resource 224a, UL WUS resource 224b, UL WUS resource 224c, and UL WUS resource 224d, beginning ‘x’ slots before paging frame 226, similar to above. The paging frame 226 includes four paging occasions (PO) 228, e.g., PO1 228a, PO2 228b, PO3 228c, and PO4 228d. Each UL WUS resource 224 is associated with a respective PO 228, e.g., UL WUS resource 224a is associated with PO1 228a, UL WUS resource 224b is associated with PO2 228b, UL WUS resource 224c is associated with PO3 228c, and UL WUS resource 224d is associated with PO4 228d.

In this example, the UL WUS resources 224 are trigged via DL trigger 234, which can be a short paging message or a PEI. Similar to above, the UL WUS is not transmitted in the first UL WUS resource 224a or the second UL WUS resource 224b. Thus, the POs 228 associated with these UL WUS resources 224, e.g., PO1 228a and PO2 228b, are muted.

The UE transmits a UL WUS 230 during the third UL WUS resource 224c (e.g., UL WUS 230a) and during the fourth UL WUS resource 224d (e.g., UL WUS 230b). The gNB receiving the UL WUS 230 can determine to send pages during the POs 228 associated with these UL WUS resources 224, e.g., in PO3 228c and PO4 228d. If the gNB decides to respond to the UE, the UE can receive a paging early indication (PEI) 232 prior to the PF 226.

In the exemplary embodiments described above, the UL WUS resource(s) can be a part of PRACH resource(s) or a separate resource(s). Each UL WUS resource may also be configured in association with one PO or one beam, as described above. In addition, each UL WUS resource may be configured in association with whether PEI is supported.

In some embodiments, the UE can be configured with a trigger condition for transmitting the UL WUS. For example, the trigger condition can comprise the UE being present in one PO, the UE being present in one beam for reception, or the UE intends to receive PEI. The trigger condition can be configured for the UE in SIB.

According to another aspect of these exemplary embodiments, the UE behavior is described for transmitting the UL WUS after triggering. In one embodiment, some preambles of PRACH are reserved for UL WUS purposes. In this embodiment, the UL WUS signal transmission procedure can comprise the preamble transmission procedure using one of the preambles reserved for UL WUS. The gNB receiving the preamble interprets the preamble reception as the UL WUS.

In another embodiment, new sequences are introduced for UL WUS purposes. When one or more new sequences are introduced for UL WUS purposes, the UL WUS transmission procedure can comprise the following steps. The UE picks a sequence for UL WUS and selects a UL WUS resource to send the UL WUS if multiple UL WUS resources are reserved. To select a UL WUS resource from among multiple available UL WUS resources, the following options can be used. In one option, the UE can measure the radio quality of the respective UL WUS resources. One SSB can be configured to be associated with one respective UL WUS resource, similar to RACH. The UE can, based on its implementation, select one UL WUS resource among the available resource(s) whose associated SSB radio quality is greater than a threshold. In another option, one RACH resource is configured to be associated with one UL WUS resource. The UE can select one UL WUS resource if its associated RACH resource is selected to send the latest preamble.

After selecting the sequence and UL WUS resource, the UE next determines the transmit power for this UL WUS transmission. In one option, the same mechanism can be used as that for determining the transmit power of the RACH preamble. This process generally comprises a retransmission procedure wherein the UE first transmits at a low power and incrementally increased the transmit power in successive retransmissions until a maximum power or a maximum number of retransmissions is reached. Separate parameters for the UL WUS transmission/retransmission procedure can be defined including, e.g., RECEIVED_TARGET_POWER, POWER_RAMPING_COUNTER and PREAMBLE_POWER_RAMPING_STEP. In another option, the transmit power can be that same as the transmit power used for the latest preamble transmission. After determining these WUS transmission parameters, the UE transmits the UL WUS.

In either of the embodiments described above, after completion of the UL WUS signal transmission, the UE can have the following behaviors. In one option, after transmission, the UL WUS transmission procedure is completed. The UE prepares to receive paging in the indicated PO and/or beam in the upcoming ‘y’ PES.

In another option, the UE monitors UE GC signaling for a response from the gNB. The GC signaling can comprise, e.g., DCI (e.g., PEI) or MAC-CE. The GC signaling can further include the POs and/or beams which the gNB will use in the upcoming ‘y’ PFs. If the confirmation signaling is received before the starting time of the upcoming PF, the UE prepares to receive paging in the indicated PO or beam in the upcoming ‘y’ PFs. If the confirmation signaling is not receive before the starting time of the upcoming PF, the UE prepares to receive paging according to legacy processes, e.g., in all beams of its PO.

In another aspect of these exemplary embodiments, the contents of the UL WUS are described. Depending on the sequence design of the UL WUS signal, the UL WUS signal may carry certain types of information in an explicit manner.

In one option, if the UL WUS resource is associated to one PO, its contents can include a suggested DL beam for paging transmission. In another option, if the UL WUS resource is associated to one beam, its contents can include the PO for the beam for paging transmission. In still another option, if the UL WUS resource is associated to whether it supports PEI, its contents can include a suggested DL beam for PEI transmission.

Alternatively, in some scenarios, the UE can indicate the above information implicitly. For example, the UE could be configured with multiple UL WUS indications (e.g., an expected beam or PO) corresponding to different resources, and the UE may select the UL WUS resource to indicate the above information implicitly.

In another aspect of these exemplary embodiments, upon reception of the UL WUS signal, the gNB detects the UL WUS signal without needing to differentiate which UE transmitted the UL WUS signal. The gNB determines whether to respond to the UE. In one example, the gNB may decide not to respond to the UL WUS request when a large number of UEs send the request and almost all POs are expected to receive paging. In this case, the gNB can decide to follow legacy paging.

If the gNB decides to respond to the UL WUS, the gNB can send UE group common signaling, e.g., PEI, to indicate the POs should be monitored in the upcoming ‘y’ PFs. The gNB can send the PEI only in the beams which are indicated by the received UL WUS. The gNB transmits paging only in the PO(s) which are indicated by UL WUS, e.g., the gNB will mute the POs which are not indicated by the UL WUS. The gNB can further send paging only in the beams which are indicated by the UL WUS.

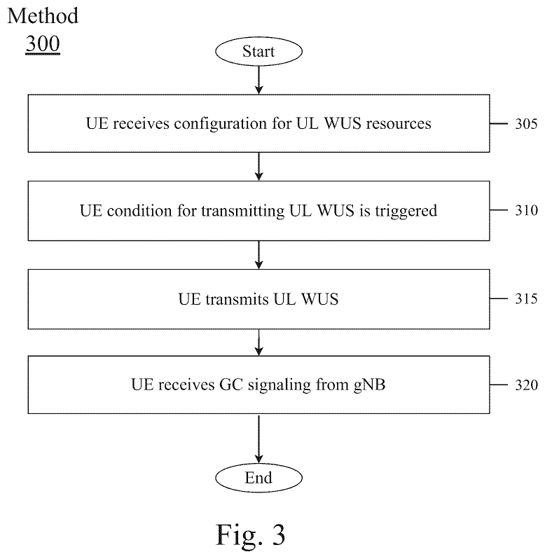

FIG. 3 shows an exemplary method 300 for configuring a UL wakeup signal (WUS) resource and transmitting a UL WUS according to various exemplary embodiments. In some embodiments, the cell configuring the UL WUS resource can implement a cell DRX/DTX cycle. As described above, the cell DRX/DTX cycle can include an ON duration during which the gNB can be in a wakeup state and an OFF duration during which the gNB can be in a sleep state of reduced operations or inactivity. In other embodiments, the cell does not implement a cell DRX/DTX cycle but can otherwise enter into a sleep state of reduced operations or inactivity. In this example, the UE is in the RRC IDLE or INACTIVE state.

In 305, the UE receives a configuration for UL WUS resources. The UL WUS resources can be periodic or aperiodic and can be signaled in SIB for the IDLE/INACTIVE UE. In some embodiments, the SIB can also indicate a cell DRX/DTX configuration. The UL WUS resources can be configured with a starting slot relative to a starting time of an upcoming paging frame (PF). If the UL WUS resources are aperiodic, the resource can be triggered via group common (GC) signaling. The configuration can indicate the slot offset and the periodicity. The UL WUS resource(s) can be part of PRACH resource(s) or separate resource(s). Each UL WUS resource can be configured to be associated with one PO or one beam. Each resource can be configured to be associated with whether it supports PEI.

The UE can also receive a configuration for a trigger condition for transmitting the UL WUS. The trigger condition can be configured in SIB. For example, the trigger condition can comprise the UE being present in one PO, the UE being present in one beam for reception, or the UE intending to receive PEI.

In 310, the condition for transmitting the UL WUS is triggered. As described above, the UE can receive the PEI or intend to receive in one PO/beam. If one or more UL WUS resources are available in an upcoming duration, the UE can initiate a UL WUS transmission procedure. If, for example, the configured UL WUS resource is aperiodic, the UE can wait until the aperiodic resource is triggered for the UE via GC signaling.

In 315, the UE transmits the UL WUS in an available UL WUS resource. To transmit the UL WUS, the UE can use a PRACH preamble reserved for UL WUS purposes or can use a new sequence introduced for UL WUS purposes. If the PRACH preamble is used, the UE can follow the same preamble transmission procedure as that used for RACH. If the new sequence is used, the UE can select a UL WUS resource for sending the UL WUS, if multiple resources are available. The UL WUS resource can be selected based on an SSB radio quality for an SSB associated with the respective resources. Alternatively, if the UL WUS resources are associated with a RACH resource, the UL WUS resource can be selected which is associated with the RACH resource selected to send the latest preamble. For transmitting the new sequence, the transmit power can be determined according to a mechanism similar to that for determining the transmit power of the PRACH preamble, e.g., increasing the transmit power incrementally for a number of retransmissions. Alternatively, the same transmit power can be used as that which was used for the latest preamble transmission.

The UL WUS can include an explicit indication of a suggested DL beam for paging transmission (if the UL WUS resource is associated to one PO), a PO for paging transmission (if the UL WUS resource is associated to one beam) or a suggested DL beam for PEI transmission (if the UL WUS resource supports PEI). This may also be indicated implicitly by selecting one from multiple UL WUS configurations corresponding to different resources.

In some embodiments, upon transmission of the UL WUS, the UE can proceed to monitor upcoming POs without expecting a confirmation from the gNB. In other embodiments, the UE can proceed to monitor upcoming POs only after receiving the confirmation, e.g., GC signaling such as PEI. The gNB receiving the WUS can determine whether to send paging in the upcoming PO(s). As described above, the gNB can make this determination based on a number of different factors. In the example of method 300, the gNB determines to send the paging in the upcoming PO(s). The gNB transmits the response to the UE and the method proceeds to 320.

In 320, the UE receives the GC signaling from the gNB, e.g., a confirmation from the gNB that the UE request was honored. The GC signaling can comprise, e.g., PEI. The UE receiving the PEI can be present in the upcoming PO(s)/beams.

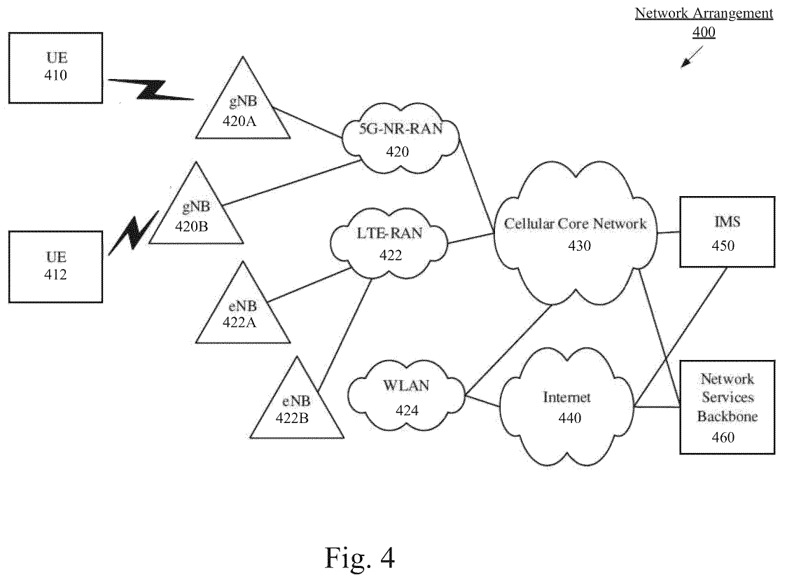

FIG. 4 shows an exemplary network arrangement 400 according to various exemplary embodiments. The exemplary network arrangement 400 includes UEs 410, 412. Those skilled in the art will understand that the UEs 410, 412 may be any type of electronic component that is configured to communicate via a network, e.g., mobile phones, tablet computers, desktop computers, smartphones, phablets, embedded devices, wearables (e. g., HMD, AR glasses, etc.), Internet of Things (IoT) devices, etc. It should also be understood that an actual network arrangement may include any number of UEs being used by any number of users. Thus, the example of two UEs 410, 412 is merely provided for illustrative purposes.

The UEs 410, 412 may communicate directly with one or more networks. In the example of the network configuration 400, the networks with which the UEs 410, 412 may wirelessly communicate are a 5G NR radio access network (5G NR-RAN) 420, an LTE radio access network (LTE-RAN) 422 and a wireless local access network (WLAN) 424. However, the UEs 410, 412 may also communicate with other types of networks and the UEs 410, 412 may also communicate with networks over a wired connection. Therefore, the UEs 410, 412 may include a 5G NR chipset to communicate UE 410 with the 5G NR-RAN 420, an LTE chipset to communicate with the LTE-RAN 422 and an ISM chipset to communicate with the WLAN 424.

The 5G NR-RAN 420 and the LTE-RAN 422 may be portions of cellular networks that may be deployed by a network carrier (e.g., Verizon, AT&T, T-Mobile, etc.). These networks 420, 422 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 424 may include any type of wireless local area network (WiFi, Hot Spot, IEEE 802.11x networks, etc.).

The UEs 410, 412 may connect to the 5G NR-RAN via the gNB 420A or the gNB 420B. Reference to two gNBs 420A, 420B is merely for illustrative purposes. The exemplary embodiments may apply to any appropriate number of gNBs. The UEs 410, 412 may also connect to the LTE-RAN 422 via the eNBs 422A, 422B. Those skilled in the art will understand that any association procedure may be performed for the UEs 410, 412 to connect to the 5G NR-RAN 420 and the LTE-RAN 422. For example, as discussed above, the 5G NR-RAN 420 and the LTE-RAN 422 may be associated with a particular cellular provider where the UEs 410, 412 and/or the user thereof has a contract and credential information (e.g., stored on a SIM card). Upon detecting the presence of the 5G NR-RAN 420, the UEs 410, 412 may transmit the corresponding credential information to associate with the 5G NR-RAN 420. More specifically, the UEs 410, 412 may associate with a specific base station (e.g., the gNB 420A of the 5G NR-RAN 420, the eNB 422A of the LTE-RAN 422).

In addition to the networks 420, 422 and 424 the network arrangement 400 also includes a cellular core network 430, the Internet 440, an IP Multimedia Subsystem (IMS) 450, and a network services backbone 460. The cellular core network 430 may be considered to be the interconnected set of components that manages the operation and traffic of the cellular network. The cellular core network 430 also manages the traffic that flows between the cellular network and the Internet 440. The IMS 450 may be generally described as an architecture for delivering multimedia services to the UE 410 using the IP protocol. The IMS 450 may communicate with the cellular core network 430 and the Internet 440 to provide the multimedia services to the UE 410. The network services backbone 460 is in communication either directly or indirectly with the Internet 440 and the cellular core network 430. The network services backbone 460 may be generally described as a set of components (e.g., servers, network storage arrangements, etc.) that implement a suite of services that may be used to extend the functionalities of the UEs 410, 412 in communication with the various networks.

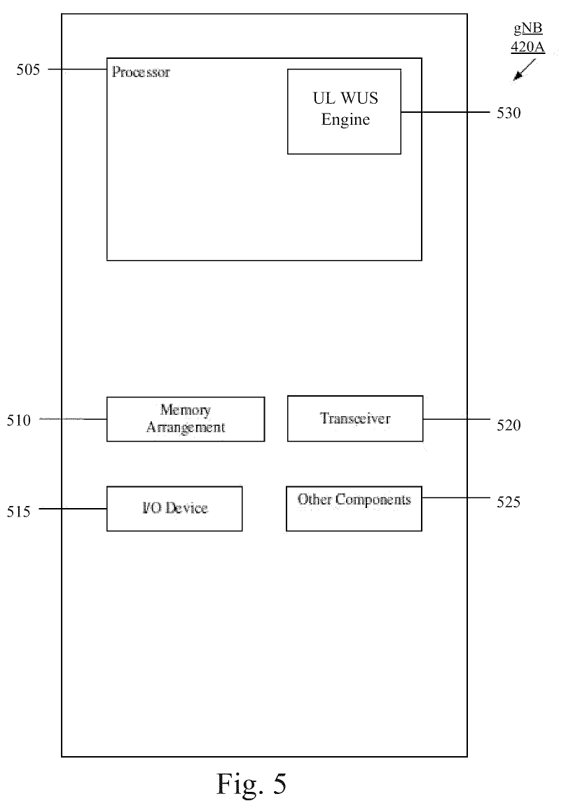

FIG. 5 shows an exemplary base station 420A according to various exemplary embodiments. The base station 420A will be described with regard to the network arrangement 400 of FIG. 4. The base station 420A may represent any access node through which the UE 410 may establish a connection and manage network operations. The base station 420A may also represent the gNB 420B described above with respect to FIG. 4.

The base station 420A may include a processor 505, a memory arrangement 510, an input/output (I/O) device 515, a transceiver 520, and other components 525. The other components 525 may include, for example, a battery, a data acquisition device, ports to electrically connect the base station 420A to other electronic devices, etc.

The processor 505 may be configured to execute a plurality of engines of the base station 420A. For example, the engines may include a UL WUS engine 530 for performing operations related to configuring the UL WUS resources for the UE, configuring trigger conditions and/or other constraints for the UL WUS, receiving the UL WUS and transmitting group common signaling confirming the wakeup in some upcoming paging occasion(s), as described above.

The above noted engine 530 being an application (e.g., a program) executed by the processor 505 is only exemplary. The functionality associated with the engine 530 may also be represented as a separate incorporated component of the base station 420A or may be a modular component coupled to the base station 420A, e.g., an integrated circuit with or without firmware. For example, the integrated circuit may include input circuitry to receive signals and processing circuitry to process the signals and other information. In addition, in some base stations, the functionality described for the processor 505 is split among a plurality of processors (e.g., a baseband processor, an applications processor, etc.). The exemplary embodiments may be implemented in any of these or other configurations of a base station.

The memory 510 may be a hardware component configured to store data related to operations performed by the base station 420A. The I/O device 515 may be a hardware component or ports that enable a user to interact with the base station 420A.

The transceiver 520 may be a hardware component configured to exchange data with the UE 410 and any other UE in the system 400. The transceiver 520 may operate on a variety of different frequencies or channels (e.g., set of consecutive frequencies). Therefore, the transceiver 520 may include one or more components (e.g., radios) to enable the data exchange with the various networks and UEs.

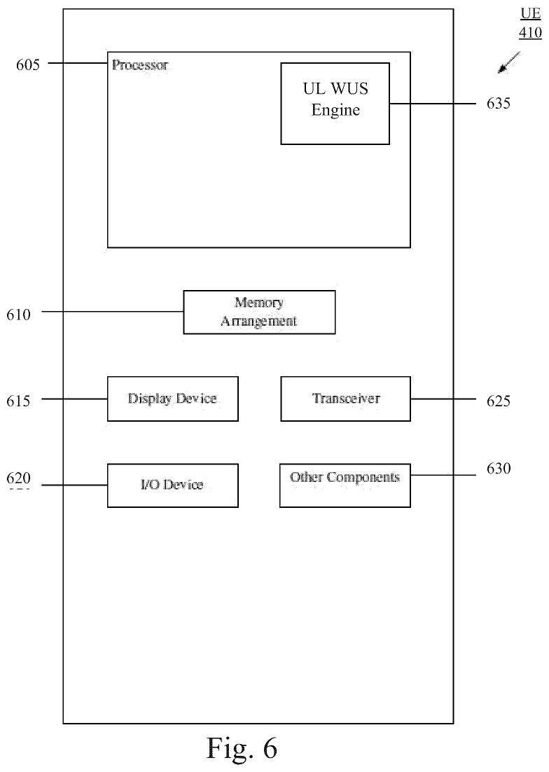

FIG. 6 shows an exemplary UE 410 according to various exemplary embodiments. The UE 410 will be described with regard to the network arrangement 400 of FIG. 4. The UE 410 may also represent UE 412. The UE 410 may include a processor 605, a memory arrangement 610, a display device 615, an input/output (I/O) device 620, a transceiver 625 and other components 630. The other components 630 may include, for example, an audio input device, an audio output device, a power supply, a data acquisition device, ports to electrically connect the UE 410 to other electronic devices, etc.

The processor 605 may be configured to execute a plurality of engines of the UE 410. For example, the engines may include a UL WUS engine 635 for performing operations related to receiving a configuration for UL WUS resources from a serving cell, determining trigger conditions are met and/or other constraints should be imposed for the UL WUS, transmitting the UL WUS and receiving an indication from the cell that paging will be sent in an upcoming PO(s), as described above.

The above referenced engine 635 being an application (e.g., a program) executed by the processor 605 is provided merely for illustrative purposes. The functionality associated with the engine 635 may also be represented as a separate incorporated component of the UE 410 or may be a modular component coupled to the UE 410, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 605 is split among two or more processors such as a baseband processor and an applications processor. The exemplary embodiments may be implemented in any of these or other configurations of a UE.

The memory arrangement 610 may be a hardware component configured to store data related to operations performed by the UE 410. The display device 615 may be a hardware component configured to show data to a user while the I/O device 620 may be a hardware component that enables the user to enter inputs. The display device 615 and the I/O device 620 may be separate components or integrated together such as a touchscreen. The transceiver 625 may be a hardware component configured to establish a connection with the 5G NR-RAN 420 and/or any other appropriate type of network. Accordingly, the transceiver 625 may operate on a variety of different frequencies or channels (e. g., set of consecutive frequencies).

### EXAMPLES

In a first example, a method performed by a user equipment (UE), comprising receiving a configuration from a network cell for an uplink (UL) wakeup signal (WUS) resource, determining to transmit a UL WUS when a condition is triggered, the condition comprising the UE being present in an upcoming paging occasion (PO) or beam or the UE intending to receive a paging early indication (PEI), selecting a sequence for transmitting the UL WUS, the sequence comprising a physical RACH (PRACH) preamble reserved for UL WUS or a sequence introduced for UL WUS and transmitting the UL WUS.

In a second example, the method of the first example, wherein the configuration for the UL WUS resource is received in a system information block (SIB).

In a third example, the method of the second example, wherein a starting slot of the UL WUS resource is configured relative to a starting time of a paging frame (PF).

In a fourth example, the method of the third example, wherein the SIB includes a parameter x and a parameter y, wherein the starting slot of the UL WUS resource is x slots before the starting time of y PFs.

In a fifth example, the method of the fourth example, wherein the configuration for the UL WUS resource further includes a periodicity.

In a sixth example, the method of the third example, wherein the UL WUS resource is aperiodic, wherein the UL WUS resource is triggered via group common signaling.

In a seventh example, the method of the sixth example, wherein the GC signaling is a downlink control information (DCI) comprising a paging short message or a paging early indication (PEI) DCI 2_7.

In an eighth example, the method of the second example, wherein when a cell discontinuous reception or discontinuous transmission (DRX/DTX) cycle is configured the UL WUS can be sent only in an ON duration of the cell DRX/DTX cycle.

In a ninth example, the method of the first example, wherein the UL WUS resources are configured as a part of PRACH resources.

In a tenth example, the method of the ninth example, wherein the PRACH preamble reserved for the UL WUS is transmitted on the UL WUS resource that is a part of PRACH resources and the UL WUS transmission comprises a preamble transmission procedure.

In an eleventh example, the method of the first example, wherein the UL WUS resource is configured separately from PRACH resources and the new sequence introduced for UL WUS is transmitted on the UL WUS resource.

In a twelfth example, the method of the eleventh example, wherein multiple UL WUS resources are available for UL WUS transmission, the method further comprising selecting one of the multiple UL WUS resources for transmitting the UL WUS.

In a thirteenth example, the method of the twelfth example, wherein a respective synchronization signal block (SSB) is configured to be associated with a respective UL WUS resource, wherein the one of the multiple UL WUS resources for transmitting the UL WUS is selected based on an associated SSB radio quality.

In a fourteenth example, the method of the twelfth example, wherein a respective RACH resource is configured to be associated with a respective UL WUS resource, wherein the one of the multiple UL WUS resources for transmitting the UL WUS is selected based on an associated RACH resource being selected to transmit a latest preamble.

In a fifteenth example, the method of the eleventh example, further comprising determining a transmit power for transmitting the UL WUS.

In a sixteenth example, the method of the fifteenth example, wherein the transmit power is determined according to a same mechanism as that which is used to determine a transmit power for transmitting the PRACH preamble, wherein separate parameters for received target power, power ramping counter, and preamble power ramping step are used for transmitting the UL WUS.

In a seventeenth example, the method of the fifteenth example, wherein the transmit power is determined as a same transmit power as that which was used for a latest preamble transmission.

In an eighteenth example, the method of the first example, wherein each UL WUS resource is configured in association with one PO or one beam.

In a nineteenth example, the method of the first example, wherein each UL WUS resource is configured in association with whether PEI is supported.

In a twentieth example, the method of the first example, wherein the UL WUS includes a suggested downlink (DL) beam for paging transmission, a PO for paging transmission, or a suggested DL beam for PEI transmission.

In an twenty first example, the method of the twentieth example, wherein the indication of which RACH resource the UE intends to trigger for RACH is indicated explicitly or implicitly based on which UL WUS resource is selected by the UE.

In an twenty second example, the method of the first example, further comprising monitoring for a response to the UL WUS.

In an twenty third example, the method of the twenty second example, wherein the response comprises group common (GC) signaling comprising downlink control information (DCI) or a medium access control (MAC) control element (MAC-CE).

In an twenty fourth example, the method of the twenty third example, further comprising detecting the response and monitoring the upcoming PO.

In an twenty fifth example, the method of the twenty third example, further comprising not detecting the response and preparing to receive paging in all beams of its PO.

In a twenty sixth example, a processor configured to perform any of the methods of the first through twenty fifth examples.

In a twenty seventh example, a user equipment comprising a transceiver configured to communicate with a network and a processor configured to perform any of the methods of the first through twenty fifth examples and communicatively coupled to the transceiver.

In a twenty eighth example, a non-transitory computer readable storage medium comprising a set of instructions that when executed perform any of the methods of the first through twenty fifth examples.

In a twenty ninth example, a method performed by a base station, comprising transmitting a configuration to a user equipment (UE) for an uplink (UL) wakeup signal (WUS) resource, receiving the UL WUS when a condition is triggered at the UE, the condition comprising the UE being present in an upcoming paging occasion (PO) or beam or the UE intending to receive a paging early indication (PEI) and determining whether to transmit paging in the upcoming PO or beam.

In a thirtieth example, the method of the twenty ninth example, wherein the configuration for the UL WUS resource is received in a system information block (SIB).

In a thirty first example, the method of the thirtieth example, wherein a starting slot of the UL WUS resource is configured relative to a starting time of a paging frame (PF).

In a thirty second example, the method of the thirty first example, wherein the SIB includes a parameter x and a parameter y, wherein the starting slot of the UL WUS resource is x slots before the starting time of y PFs.

In a thirty third example, the method of the thirty second example, wherein the configuration for the UL WUS resource further includes a periodicity.

In a thirty fourth example, the method of the thirty first example, wherein the UL WUS resource is aperiodic, wherein the UL WUS resource is triggered via group common signaling.

In a thirty fifth example, the method of the thirty fourth example, wherein the GC signaling is a downlink control information (DCI) comprising a paging short message or a paging early indication (PEI) DCI 2_7.

In a thirty sixth example, the method of the thirtieth example, wherein when a cell discontinuous reception or discontinuous transmission (DRX/DTX) cycle is configured the UL WUS can be sent only in an ON duration of the cell DRX/DTX cycle.

In a thirty seventh example, the method of the twenty ninth first example, wherein the UL WUS resources are configured as a part of PRACH resources.

In a thirty eighth example, the method of the thirty seventh example, wherein the PRACH preamble reserved for the UL WUS is transmitted on the UL WUS resource that is a part of PRACH resources and the UL WUS transmission comprises a preamble transmission procedure.

In a thirty ninth example, the method of the twenty ninth example, wherein the UL WUS resource is configured separately from PRACH resources and the new sequence introduced for UL WUS is transmitted on the UL WUS resource.

In a fortieth example, the method of the thirty ninth example, wherein multiple UL WUS resources are available for UL WUS transmission and the UE selects one of the multiple UL WUS resources for transmitting the UL WUS.

In a forty first example, the method of the fortieth example, wherein a respective synchronization signal block (SSB) is configured to be associated with a respective UL WUS resource, wherein the one of the multiple UL WUS resources for transmitting the UL WUS is selected based on an associated SSB radio quality.

In a forty second example, the method of the fortieth example, wherein a respective RACH resource is configured to be associated with a respective UL WUS resource, wherein the one of the multiple UL WUS resources for transmitting the UL WUS is selected based on an associated RACH resource being selected to transmit a latest preamble.

In a forty third example, the method of the twenty ninth example, wherein each UL WUS resource is configured in association with one PO or one beam.

In a forty fourth example, the method of the twenty ninth example, wherein each UL WUS resource is configured in association with whether PEI is supported.

In a forty fifth example, the method of the twenty ninth example, wherein the UL WUS includes a suggested downlink (DL) beam for paging transmission, a PO for paging transmission, or a suggested DL beam for PEI transmission.

In a forty sixth example, the method of the twenty ninth example, wherein the indication of a RACH resource the UE intends to trigger for RACH is indicated explicitly or implicitly based on which UL WUS resource is selected by the UE.

In a forty seventh example, the method of the twenty ninth example, further comprising transmitting a response to the UL WUS.

In a forty eighth example, the method of the forty seventh example, wherein the response comprises group common (GC) signaling comprising downlink control information (DCI) or a medium access control (MAC) control element (MAC-CE).

In a forty ninth example, a processor configured to perform any of the methods of the twenty ninth through forty eighth examples.

In a fiftieth example, a base station comprising a transceiver configured to communicate with a user equipment (UE) and a processor configured to perform any of the methods of the twenty ninth through forty eighth examples and communicatively coupled to the transceiver.

In a fifty first example, a non-transitory computer readable storage medium comprising a set of instructions that when executed perform any of the methods of the twenty ninth through forty eighth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. A method performed by a user equipment (UE), comprising:
receiving a configuration from a network cell for an uplink (UL) wakeup signal (WUS) resource;
determining to transmit a UL WUS when a condition is triggered, the condition comprising the UE being present in an upcoming paging occasion (PO) or beam or the UE intending to receive a paging early indication (PEI);
selecting a sequence for transmitting the UL WUS, the sequence comprising a physical RACH (PRACH) preamble reserved for UL WUS or a sequence introduced for UL WUS; and
transmitting the UL WUS.

2. The method of claim 1, wherein the configuration for the UL WUS resource is received in a system information block (SIB).

3. The method of claim 2, wherein a starting slot of the UL WUS resource is configured relative to a starting time of a paging frame (PF).

4. The method of claim 2, wherein when a cell discontinuous reception or discontinuous transmission (DRX/DTX) cycle is configured the UL WUS is sent only in an ON duration of the cell DRX/DTX cycle.

5. The method of claim 1, wherein the UL WUS resources are configured as a part of PRACH resources.

6. The method of claim 1, wherein the UL WUS resource is configured separately from PRACH resources and the sequence introduced for UL WUS is transmitted on the UL WUS resource.

7. The method of claim 1, wherein each UL WUS resource is configured in association with one PO or one beam.

8. The method of claim 1, wherein each UL WUS resource is configured in association with whether PEI is supported.

9. The method of claim 1, wherein the UL WUS includes a suggested downlink (DL) beam for paging transmission, a PO for paging transmission, or a suggested DL beam for PEI transmission.

10. The method of claim 1, further comprising:
monitoring for a response to the UL WUS.

11. A method performed by a base station, comprising:
transmitting a configuration to a user equipment (UE) for an uplink (UL) wakeup signal (WUS) resource;
receiving the UL WUS when a condition is triggered at the UE, the condition comprising the UE being present in an upcoming paging occasion (PO) or beam or the UE intending to receive a paging early indication (PEI); and
determining whether to transmit paging in the upcoming PO or beam.

12. The method of claim 11, wherein the configuration for the UL WUS resource is received in a system information block (SIB).

13. The method of claim 12, wherein a starting slot of the UL WUS resource is configured relative to a starting time of a paging frame (PF).

14. The method of claim 12, wherein when a cell discontinuous reception or discontinuous transmission (DRX/DTX) cycle is configured the UL WUS is sent only in an ON duration of the cell DRX/DTX cycle.

15. The method of claim 11, wherein the UL WUS resources are configured as a part of PRACH resources.

16. The method of claim 11, wherein the UL WUS resource is configured separately from PRACH resources and the sequence introduced for UL WUS is transmitted on the UL WUS resource.

17. The method of claim 11, wherein each UL WUS resource is configured in association with one PO or one beam.

18. The method of claim 11, wherein each UL WUS resource is configured in association with whether PEI is supported.

19. The method of claim 11, wherein the UL WUS includes a suggested downlink (DL) beam for paging transmission, a PO for paging transmission, or a suggested DL beam for PEI transmission.

20. The method of claim 11, wherein a RACH resource the UE intends to trigger for RACH is indicated explicitly or implicitly based on which UL WUS resource is selected by the UE.
